(19) United States
(12) Patent Application Publication
(10) Pub. No.: US 2022/0081122 A1
(43) Pub. Date: Mar. 17, 2022

(54) METHOD AND DEVICE FOR MANAGING THE ENERGY SUPPLIED BY A HYBRID POWER PLANT FOR A ROTORCRAFT

(71) Applicant: AIRBUS HELICOPTERS, Marignane (FR)

(72) Inventor: Marc GAZZINO, Marseille (FR)

(73) Assignee: AIRBUS HELICOPTERS, Marignane (FR)

(21) Appl. No.: 17/447,212

(22) Filed: Sep. 9, 2021

(30) Foreign Application Priority Data
Sep. 14, 2020 (FR) 2009286

(51) Int. Cl. B64D 31/00; B64D 27/24; B60L 50/00; B60L 58/00; B64C 27/06

(52) U.S. Cl. CPC B64D 31/00; B64D 27/24; B64D 2027/026; B60L 58/00; B64C 27/06; B60L 50/00

(57) ABSTRACT

A method for managing the energy supplied by a hybrid power plant for propelling a rotorcraft, the hybrid power plant comprising two heat engines, two electric motors and an electrical energy source. The method includes a step of acquiring at least one first characteristic of the electrical energy source and/or the electric motors and a step of determining a mechanical power requirement of the rotorcraft. The method then includes a step of determining a first power distribution between each heat engine and electric motor as a function of the first characteristic and the mechanical power requirement of the rotorcraft, then a step of controlling each heat engine and electric motor according to several operating modes, including a distributed operating mode applying the first power distribution.

### CROSS-REFERENCE TO RELATED APPLICATIONS

This application claims priority to French patent application No. FR 20 09286 filed on Sep. 14, 2020, the disclosure of which is incorporated in its entirety by reference herein.

### TECHNICAL FIELD

The present disclosure lies in the technical field of hybrid power plants for aircraft, and more particularly hybrid power plants for rotorcraft.

The disclosure relates to a method of managing the energy supplied by a hybrid power plant for propelling a rotorcraft. The disclosure also relates to a hybrid power plant for propelling a rotorcraft and to a rotorcraft comprising such a hybrid power plant.

### BACKGROUND

A rotorcraft is conventionally provided with at least one main rotor for providing its lift, or indeed its propulsion.

A rotorcraft may also comprise an auxiliary rotor, for example a rear rotor, in particular in order to oppose the yaw torque exerted by the main rotor on the fuselage of the rotorcraft and control yaw movements of the rotorcraft.

A rotorcraft may also include one or more forward propellers intended mainly for propelling the rotorcraft. This or these forward propeller or propellers may also help oppose the yaw torque exerted by the main rotor on the fuselage of the rotorcraft and control its yaw movements.

A rotorcraft may also comprise several main rotors, for example at least three main rotors, to provide its lift, propulsion and manoeuvrability. Such a rotorcraft may be referred to as a “multirotor rotorcraft”.

In order to rotate each main rotor and, possibly, the auxiliary rotor and/or each forward propeller, a rotorcraft is provided with a power plant generally comprising one or more heat engines, as well as a gearbox arranged between the main rotor and the heat engine or engines. A distinction is made in particular between “single-engine” rotorcraft, in which the power plant comprises a single heat engine for setting the main rotor and the rear rotor in motion, and “twin-engine” rotorcraft, in which the power plant has two heat engines for this purpose.

A power plant may optionally also include one or more electric motors. A power plant comprising one or more heat engines and at least one electric motor is generally referred to as a “hybrid power plant”. A hybrid power plant also comprises one or more electrical energy sources such as a battery, a supercapacitor or a fuel cell, for example, in order to supply each electric motor with electrical energy. Some electrical energy sources are rechargeable electrical energy storage devices.

An electric motor may be installed in different ways in a hybrid power plant.

For example, an electric motor may be connected to a heat engine, in particular to a gas generator of a turboshaft engine. This electric motor rotates the rotating shaft of this gas generator and consequently also supplies mechanical power to the gearbox. Such a hybrid power plant architecture relates, in particular, to a low-power electric motor and may be referred to by the expression “micro-hybridization”.

An electric motor may also be installed on the power transmission system of the hybrid power plant, connected, for example, to a specific input of the gearbox or else connected to an output of the gearbox, for example between the gearbox and a rotor of the rotorcraft, preferably the main rotor.

Such a hybrid power plant architecture in which at least one electric motor is installed in the mechanical power transmission system can be referred to as “mild-hybridization”.

An electric motor of a hybrid power plant may be used only in motor mode in order to convert electrical energy into mechanical energy for rotating a main rotor. An electric motor may also be a reversible electric machine combining the motor mode with a generator mode in order to convert mechanical energy into electrical energy to recharge a rechargeable electrical energy source or supply this electrical energy to an electrical network of the rotorcraft.

A hybrid power plant may also include an electricity generator used only in generator mode and intended to convert mechanical energy into electrical energy.

It should be noted that, in the interest of convenience, the term “heat engine” refers throughout the text to any heat engine that can be used in such a power plant for a rotorcraft, for example turboshaft engines or else piston engines. The term “heat engine” is used in contrast to the term “electric motor”, which describes motors driven by electrical energy.

Heat engines and electric motors can be used independently or in combination, simultaneously or sequentially to propel the rotorcraft.

An electric motor may, for example, intervene in the event of a failure of a heat engine.

Document FR 2 997 382 describes, in particular, a hybrid power plant for a rotorcraft equipped with two heat engines, an electric machine, a main gearbox and an electrical energy storage means. Following the detection of a failure of a heat engine, the electric machine supplies, if necessary, auxiliary power in order to compensate for the failure and to allow the pilot of the rotorcraft to maneuver the rotorcraft safely without damaging the other functional heat engine.

Documents FR 2 994 687 and FR 3 090 576 describe a hybrid power plant for a rotorcraft equipped with a single heat engine, an electric motor, a main gearbox and an electrical energy storage means. In the event of a failure of the heat engine, the electric motor supplies mechanical power in order to assist the pilot of the rotorcraft in carrying out an autorotation flight phase following the failure.

An electric motor may also be installed to limit the power of each installed heat engine, as described in documents FR 2 933 910 and FR 2 952 907, the electric motor being used in combination and simultaneously with at least one heat engine.

For example, according to document FR 2 933 910, a hybrid power plant comprises at least one turboshaft engine and at least one electric motor mechanically connected to a main gearbox. The electric motor is used to start a heat engine and during a transient phase with a high energy requirement. The electric motor may also be used in generator mode.

According to document FR 2 952 907, a hybrid power plant comprises a single heat engine, a main gearbox intended to drive a main rotor and a tail rotor gearbox intended to drive an auxiliary rotor, as well as a first electric motor mechanically connected to the main gearbox and a second electric motor mechanically connected to the tail rotor gearbox.

Document US 2019/0291852 describes a multirotor aircraft, each rotor of which is driven by a hybrid engine comprising at least one heat engine and at least one electric motor. A clutch system, for example a free-wheel, allows each heat engine and/or electric motor to be connected to the rotor. Sensors connected to the electric motors and/or to the rotors measure at least one operating parameter of these electric motors. An embedded processor is provided for controlling each heat engine and electric motor and, optionally, the clutch system, so that each heat engine and/or electric motor provides a predetermined power as a function of a predefined flight characteristic. For example, the heat engine(s) and electric motor(s) provide their maximum power levels for the aircraft's take off; then, once a predetermined altitude has been reached, only the electric motors are used in cruising flight. In the event of low electrical energy in the batteries, the heat engines are used to ensure flight and recharge the batteries.

Document EP 2 327 625 describes a hybrid power plant for a rotary-wing aircraft comprising a single heat engine and two electric motors as well as at least one electric battery. A first electric motor is connected to a main gearbox and a second electric motor is connected to a tail rotor gearbox. In normal operation, the heat engine alone drives the main gearbox and the tail rotor gearbox. The electric motors intervene in the event of an incident or failure of the heat engine in order to drive, respectively, a main rotor and a rear rotor of the aircraft, in order to allow the aircraft to fly to a landing point. The power plant may include a control member controlling the electric motors according to predetermined laws. Moreover, in the event of overspeed in the heat engine, the electric motors operate in generator mode in order to reduce the speed of rotation of the heat engine.

Document EP 2 684 798 describes an electrical architecture for an aircraft provided with a hybrid power plant allowing management of the electrical energy on board the aircraft, the hybrid power plant including at least one heat engine and at least one reversible electric motor as well as at least one electrical energy store and, possibly, an electric current generator. The electrical architecture includes a calculator for controlling the electrical energy supply from an electrical energy store or indeed from an electric motor based on operating information of the heat engine, the electric motor, and the electrical energy store. The calculator controls, for example, the operation of an electric motor to start a heat engine.

Document US 2020/0277064 describes a control module connected to a hybrid power plant having a heat engine and an electric motor in order to control the output torques of the heat engine and the electric motor. The control module may be configured to determine whether at least one electric motor or one heat engine is in a normal mode such that the electric motor and/or the heat engine may provide torque. The control module can determine and apply a torque distribution between the electric motor and the heat engine as a function of various parameters, which may or may not be measured, in particular relating to the battery, in order to reach a total torque value.

Document DE 10 2010 021026 describes a hybrid propulsion system for an aircraft, in particular a rotary-wing aircraft, comprising an electrical energy generation module provided with a heat engine and a generator, and one or more electric motors for driving one or more rotors of the aircraft. Sensors are positioned on the control members of the aircraft to measure their movements, to deduce therefrom the intentions of the pilot of the aircraft, and to deduce therefrom the thrust necessary for each rotor of the aircraft.

Moreover, the technological background includes documents EP 2 692 634 and EP 2 778 048 describing systems for storing energy during normal operation of a rotorcraft and for releasing this energy in order to drive the main rotor of the rotorcraft in the event of an engine failure or else during critical flight phases. The energy can be stored in electrical, hydraulic or indeed mechanical form.

The use of an electric motor can thus help overcome a failure of a heat engine, and compensate for a need for transient energy for driving a main rotor and, possibly, an auxiliary rotor and/or forward propellers.

However, each electric motor is used mainly depending on the needs of the rotorcraft and/or of the hybrid power plant, without taking into account or optimizing the available electrical energy and/or the state of each electrical energy source.

### SUMMARY

An object of the present disclosure is therefore to propose a method and a device for managing the energy supplied by a hybrid power plant for propelling a rotorcraft that makes it possible to overcome the above-mentioned limitations, by proposing an alternative solution to the operation of the hybrid power plant and, in particular, of each heat engine and electric motor, by supervising the various electrical energy source used.

The present disclosure relates firstly to a method for managing the energy supplied by a hybrid power plant for propelling a rotorcraft, the rotorcraft comprising:

a hybrid power plant provided with at least one heat engine, at least one electric motor, a main gearbox, at least one electrical energy source, one control unit for each heat engine, one control device for each electric motor and at least one sensor for monitoring said at least one electrical energy source or said at least one electric motor;

at least one main rotor rotated by the hybrid power plant; and

at least one calculator.

The method according to the disclosure is remarkable in that it includes the following steps:

acquiring at least one first characteristic of said at least one electrical energy source and/or said at least one electric motor by means of at least one sensor;

determining a mechanical power requirement of the rotorcraft;

determining a first power distribution between said at least one heat engine and said at least one electric motor as a function of said at least one first characteristic and the mechanical power requirement of the rotorcraft; and

controlling said at least one heat engine and said at least one electric motor via said at least one control unit and said at least one control device, respectively, according to a distributed operating mode, the distributed operating mode applying the first power distribution.

In this way, the method for managing the energy supplied by a hybrid power plant for propelling a rotorcraft according to the disclosure makes it possible to control the hybrid power plant and, in particular, each heat engine and each electric motor based on the state of each electrical energy source. The calculator thus receives state information from each of the electrical energy sources and sends usage instructions to the heat engine(s) and electric motor(s) in order to optimize the operation of the hybrid power plant according to the first mechanical power distribution provided by each heat engine and by each electric motor.

The hybrid power plant may comprise a single heat engine or several heat engines, typically two heat engines. The gearbox is arranged between the main rotor and each heat engine.

Each control unit is used to control and monitor a heat engine. Each control unit can thus measure or estimate operating parameters of the heat engine. By way of example, a control unit may be an EECU (Electronic Engine Control Unit) or FADEC (Full Authority Digital Engine Control) engine calculator.

Each control device may also be used to control and monitor an electric motor.

The calculator may be dedicated solely to implementing the energy management method according to the disclosure. The calculator may be housed by a control unit or a control device, for example. The calculator may also be shared with other functions of the rotorcraft and be integrated, for example, into an avionics system of the rotorcraft.

The hybrid power plant may include one or more electric motors as well as one or more electrical energy sources, for example a battery, a supercapacitor or a fuel cell, in order to supply each electric motor with electrical energy. An electrical energy source may be a rechargeable electrical energy storage device.

An electric motor may be connected directly to a heat engine, in particular to a gas generator of a turboshaft engine, or indeed be installed between a heat engine and the main gearbox, or indeed be installed at a specific input of the gearbox.

An electric motor of the hybrid power plant may be used only in motor mode in order to convert electrical energy into mechanical energy for rotating the main rotor. An electric motor may combine the motor mode with a generator mode in order to convert mechanical energy into electrical energy in order to recharge a rechargeable electrical energy source or supply this electrical energy to an electrical network of the rotorcraft. The hybrid power plant may also include an electricity generator used only in generator mode.

During the step of acquiring at least one first characteristic of said at least one electrical energy source and/or said at least one electric motor by means of at least one sensor, said at least one first characteristic may be chosen from the following list:

a state of charge of said at least one electrical energy source;

a depth of discharge of said at least one electrical energy source;

a temperature of said at least one electrical energy source;

a state of health of said at least one electrical energy source; and

a temperature of the at least one electric motor.

Each sensor for acquiring a first characteristic is integrated into the hybrid power plant. For a first characteristic of an electrical energy source, the sensor may be integrated into the electrical energy source. For a first characteristic of an electric motor, the sensor may be integrated into the control device of this electric motor or into the electric motor depending, for example, on the first characteristic that it measures.

The step of determining a mechanical power requirement of the rotorcraft may be carried out in a conventional manner, for example as a function of the mass of the rotorcraft, its forward speed, its vertical speed and the values of the collective pitch and cyclic pitch controls of the main rotor blades.

The rotorcraft may include a device dedicated to determining this mechanical power requirement of the rotorcraft. An avionics system equipping the rotorcraft may also determine this mechanical power requirement as a function of information provided by various sensors of the rotorcraft. The calculator can also determine this mechanical power requirement from such information.

To this end, the method according to the disclosure may include a step of acquiring at least one second characteristic of the rotorcraft and/or of the hybrid power plant, said at least one second characteristic possibly being information used during the step of determining a mechanical power requirement of the rotorcraft. This step of acquiring at least one second characteristic may be carried out by means, for example, of at least one specific sensor present in the rotorcraft.

A second characteristic may be chosen from the following list:

speed of rotation of a heat engine;

temperature of a heat engine;

state of health of a heat engine;

speed of rotation of the main rotor;

altitude of the rotorcraft;

forward speed of the rotorcraft;

vertical speed of the rotorcraft;

value of the collective pitch control of the main rotor blades; and

value of the cyclic pitch control of the main rotor blades.

Next, the step of determining a first power distribution between said at least one heat engine and said at least one electric motor can be carried out by means of the calculator, as a function of said at least one first characteristic and the mechanical power requirement of the rotorcraft.

The first power distribution is determined by taking into account, in particular, the quantity of electrical energy that each electrical energy source can supply, for example the quantity of electrical energy available in a battery or the quantity of electrical energy that a fuel cell can generate. The first power distribution is also determined by taking into account, in particular, the operating conditions of each electrical energy source, in particular its temperature and its state of health, as well as its state of charge. The state of health of a battery corresponds, for example, to its ageing. The state of charge of a battery corresponds, for example, to the quantity of energy available in the battery.

The first power distribution may also be determined based on the mechanical power that each electric motor can actually supply, taking into account, in particular, the temperature of each electric motor and the quantity of electrical energy available in each source, it being possible to modify the power level supplied by the electric motor as a function of this temperature.

In this way, the method according to the disclosure makes it possible to determine the mechanical power supplied by each heat engine and the mechanical power supplied by each electric motor in order to propel the rotorcraft while optimizing the use of each electrical energy source.

Each electric motor thus provides additional mechanical power to the main gearbox, in addition to the power provided by each heat engine in order to rotate at least one output shaft of the main gearbox of the hybrid power plant, thus improving the performance of the hybrid power plant.

According to the first power distribution, the use of the mechanical energy of each electric motor in addition to the mechanical energy of each heat engine may make it possible, in particular, to optimize the overall fuel consumption of each heat engine and/or to increase the performance of the rotorcraft, for example its maximum take-off weight.

Next, the step of controlling said at least one heat engine and said at least one electric motor is carried out via said at least one control unit and said at least one control device, respectively, according to a distributed operating mode, in order to propel the rotorcraft, the distributed operating mode applying said first power distribution.

By applying the first power distribution of the mechanical energy supplied by each heat engine and by each electric motor, the method according to the disclosure advantageously makes it possible to supervise the various electrical energy sources and their use while the rotorcraft is flying in order to ensure the propulsion of the rotorcraft.

The method according to the disclosure may include one or more of the following features, taken individually or in combination.

According to one example, the method according to the disclosure may include different operating modes of the hybrid power plant, ensuring energy management in order to optimize the use of the different energy sources depending, for example, on the flight conditions or the mission to be performed.

To this end, the method may comprise the following steps:

selecting an operating mode to select an operating mode of the hybrid power plant by means of a selection device; and

controlling said at least one heat engine and said at least one electric motor via said at least one control unit and said at least one control device, respectively, according to the operating mode selected from among the following operating modes depending on the selection:
the previously described distributed operating mode;
a total operating mode during which the power supplied by the hybrid power plant is increased, each heat engine supplying the maximum available power and each electric motor supplying the maximum available power within the limits of the rotorcraft's capability; and
a “low-emission” operating mode applying a second power distribution between said at least one heat engine and said at least one electric motor, the second power distribution limiting polluting emissions from the hybrid power plant for the environment outside the rotorcraft.

The selection device may be a manual selector with several positions, such as a rotary knob provided with several positions, or may comprise a screen and a touch panel, for example.

The total operating mode makes it possible to provide the maximum available power, for example in order to perform a demanding maneuver, transport a heavy payload, increase the maximum flight altitude of the rotorcraft, etc.

The second power distribution may be predetermined. For example, according to the second power distribution, said at least one electric motor supplies the maximum available power and energy and said at least one heat engine supplies additional power depending on the mechanical power requirement of the rotorcraft.

The second power distribution may also be calculated in real time by the calculator as a function of at least one first characteristic and the power requirement, and even, possibly, at least one second characteristic. The second power distribution takes into account the state of the electrical energy sources, based on the power and use time constants, or quantities of energy available for each heat engine, each electric motor and each electrical energy source.

In this case, the method according to the disclosure may comprise a step of determining a second power distribution between said at least one heat engine and said at least one electric motor as a function of said at least one first characteristic and the mechanical power requirement of the rotorcraft, and possibly at least one second characteristic.

The second power distribution may advantageously make it possible to manage the power demands of the hybrid power plant by using at least one electric motor in order to limit the load on each heat engine and therefore the polluting emissions. The power demands of the hybrid power plant may differ depending on the flight phases and correspond, for example, to the take-off, landing, altitude increase and manoeuvring phases.

The second power distribution may allow optimal use of the electrical energy stored and/or provided by each electrical energy source in order to limit the use of each heat engine. The second power distribution may thus make it possible to filter the power peaks of each heat engine in order to reduce its fuel consumption and improve its service life.

According to another example, the step of determining a first power distribution uses at least one second characteristic to determine said first power distribution. In this way, the first power distribution takes into account the operating conditions of the rotorcraft and the power plant in order to optimize this power distribution between each heat engine and each electric motor.

According to another example, the method according to the disclosure may include a step of determining a flight phase of the rotorcraft. The flight phase determined in this way may be taken into account during the steps of determining the first power distribution and the second power distribution. The flight phase may be determined, for example, as a function of one or more second characteristics of the rotorcraft and/or of the hybrid power plant. Knowing the flight phase makes it possible to optimize the first power distribution and/or the second power distribution.

According to another example, irrespective of the selected operating mode, the first power distribution or the second power distribution is determined so that at least one electric motor operates in an electrical energy generator mode so as to recharge at least one source, when possible, depending on the power requirement of the rotorcraft.

According to another example, the step of determining a first power distribution may take into account the preservation of a backup electrical energy reserve for at least one electrical energy source. In this case, at least one electrical energy source is available to supply electrical energy in the event of an emergency, at any time during the flight, for example in the event of a failure of a heat engine or the need for significant power for a demanding or emergency maneuver. This backup reserve thus provides a margin of safety when using the rotorcraft, for example to cross a mountain, fly over a hostile area, etc. In this case, priority is given to the availability of backup electrical energy. This backup reserve is thus used to supply at least one electric motor to assist the end of level flight and landing with a limited duration of use.

The preservation of a backup electrical energy reserve for at least one electrical energy source may also be taken into account for the total operating mode and/or the “low-emission” operating mode.

According to another example, the step of determining a first power distribution takes into account the flight plan of the rotorcraft such that each electrical energy source no longer contains any electrical energy at the end of the flight. In this way, the use of each source is optimized according to the flight plan. Thus, if a backup reserve has been preserved during the flight phase, this backup reserve may be used during the landing phase carried out at the end of the flight plan.

The present disclosure also relates to a hybrid power plant for a rotorcraft, the hybrid power plant applying the method as described above.

The hybrid power plant comprises at least one heat engine, at least one electric motor, a main gearbox, at least one electrical energy source, one control unit for each heat engine, one control device for each electric motor and at least one sensor for monitoring said at least one electrical energy source or said at least one electric motor.

The hybrid power plant may include a calculator configured to implement the method as described above. The hybrid power plant may also include a device for managing the energy supplied to the hybrid power plant for propelling the rotorcraft, the energy management device being provided with at least one calculator and configured to implement the method as described above.

Finally, the present disclosure relates to a rotorcraft comprising a hybrid power plant as described above and at least one main rotor rotated by the hybrid power plant.

### BRIEF DESCRIPTION OF THE DRAWINGS

The disclosure and its advantages appear in greater detail in the context of the following description of embodiments given by way of illustration and with reference to the accompanying figures, in which:

FIG. 1 is a view of a rotorcraft according to the disclosure;

FIG. 2 is an overview diagram of a method according to the disclosure; and

FIG. 3 is an overview diagram of a method according to the disclosure.

### DETAILED DESCRIPTION

Elements that are present in more than one of the figures are given the same references in each of them.

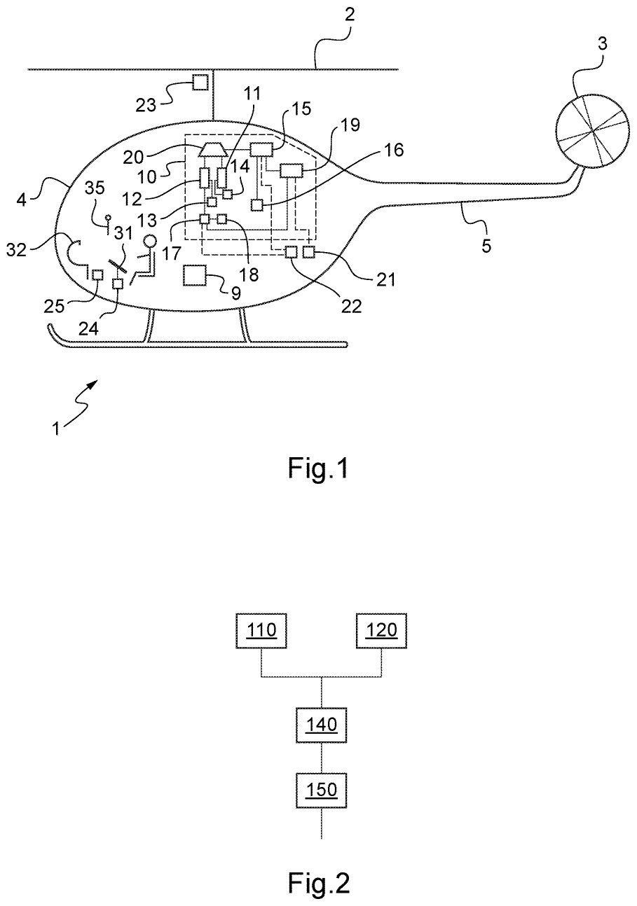

FIG. 1 shows a rotorcraft 1 comprising a fuselage 4, a main lift rotor 2 and an auxiliary rotor 3 arranged at a free end of a tail boom 5. The main rotor 2 and the auxiliary rotor 3 respectively comprise a rotating hub and blades. The rotorcraft 1 also comprises a hybrid power plant 10 that rotates the main lift rotor 2 and the auxiliary rotor 3.

The hybrid power plant 10 may include at least one heat engine 11, 12, at least one electric motor 15, 17, a main gearbox 20, at least one electrical energy source 19, one control unit 13, 14 for each heat engine 11, 12, one control device 16, 18 for each electric motor 15, 17, and at least one sensor 21, 22 for monitoring each electrical energy source 19 or each electric motor 15, 17.

According to FIG. 1, the hybrid power plant 10 comprises two heat engines 11, 12, two electric motors 15, 17, a main gearbox 20, an electrical energy source 19, one control unit 13, 14 for each heat engine 11, 12, one control device 16, for each electric motor 15, 17, a sensor 21 for monitoring the electrical energy source 19 and a sensor 22 for monitoring the electric motors 15, 17.

The two heat engines 11, 12 are connected to the main gearbox 20. Each heat engine 11, 12 may, for example, have a nominal power of the order of 400 to 600 kilowatts (400 to 600 kW). These heat engines 11, 12 may, for example, be turboshaft engines or else piston engines.

A first electric motor 15 is also connected to the main gearbox 20. This first electric motor 15 may, for example, have a nominal power of the order of 100 to 300 kW. This first electric motor 15 constitutes a transient power source for the hybrid power plant 10 and has operating times in motor mode of a few dozen seconds to a few minutes, for example.

A second electric motor 17 is connected directly to one of the heat engines 11, 12. This second electric motor 17 may, for example, have a nominal power of the order of 10 to 20 kW. This second electric motor 17 has short operating times, of the order of a few seconds. This second electric motor 17 may be used, in particular, to start the heat engine 11, 12 to which it is connected and to supply it, in a transient manner, with a small amount of surplus power.

The rotorcraft 1 also includes control means 31, 32 and a selection device 35. A control stick 31 is intended to collectively modify the pitch of the blades of the main rotor 2 while a control lever 32 is intended to cyclically modify the pitch of the blades of the main rotor 2. The rotorcraft 1 also comprises a sensor 23 measuring the speed of rotation of the main rotor 2 and two sensors 24, 25 measuring the travels of the control stick 31 and of the control lever 32 respectively.

The hybrid power plant 10 also comprises a calculator configured to implement a method for managing the energy supplied by the hybrid power plant 10 for propelling the rotorcraft 1. By way of example, the calculator 9 may comprise at least one processor and at least one memory, at least one integrated circuit, at least one computer, at least one programmable system, or at least one logic circuit, these examples not limiting the scope to be given to the term “calculator”. The term “processor” may refer equally to a central processing unit (CPU), a graphics processing unit (GPU), a digital signal processor (DSP), a microcontroller, etc.

The calculator 9 is thus connected by wired or wireless means to the sensors 21, 22, the control units 13, 14 and the control devices 16, 18, as well as, possibly, to the sensors 23, 24, 25.

The calculator 9 may also be hosted by a control unit 13, 14, a control device 16, 18 or else be shared with other functions of the rotorcraft 1 and be integrated, for example, into an avionics system of the rotorcraft 1.

FIG. 2 is an overview diagram of this energy management method. This method may include four main steps.

Firstly, a step 110 of acquiring at least one first characteristic of the electrical energy source 19 and/or of each electric motor 15, 17 is carried out by means of the sensors 21, 22.

A first characteristic of the electrical energy source 19 may be a state of charge of the electrical energy source 19, a depth of discharge of the electrical energy source, a temperature of the electrical energy source 19 and a state of health of the electrical energy source 19. A first characteristic of the electric motors 15, 17 may be a temperature of an electric motor 15, 17.

The first characteristics of the source 19 acquired during this acquisition step 110 can be used to define the current state of the electrical energy source 19, and to deduce therefrom the ability of the source 19 to supply electrical energy and the quantity of electrical energy that the source 19 can supply. The first characteristics of the source 19 acquired during this acquisition step 110 can also be used to define the quantity of electrical energy that each electric motor 15, 17 can use and to deduce therefrom the mechanical power that each heat engine 15, 17 can deliver.

A step 120 of determining a mechanical power requirement of the rotorcraft 1 is carried out in a conventional manner, for example as a function of the mass of the rotorcraft 1, its forward speed, its vertical speed and the values of the collective pitch and cyclic pitch controls of the blades of the main rotor 2.

The step 120 of determining a mechanical power requirement of the rotorcraft 1 is carried out, for example, by means of the calculator 9, using such information. The step 120 of determining a mechanical power requirement of the rotorcraft 1 may also be performed by an avionics system of the rotorcraft 1 or a dedicated device.

The acquisition step 110 and the determination step 120 are preferably performed in parallel. However, the acquisition step 110 and the determination step 120 may be performed sequentially.

Next, a step 140 of determining a first power distribution between the heat engines 11, 12 and the electric motors 15, 17 as a function of at least one first characteristic and the mechanical power requirement of the rotorcraft 1 is carried out by means of the calculator 9.

During this step 140 of determining the first power distribution, the first power distribution is determined on the basis of the quantity of electrical energy that the electrical energy source 19 can supply and the operating conditions of the electrical energy source 19, for example its temperature, state of health and depth of discharge. The first power distribution is determined based on the mechanical power that each electric motor 15, 17 can actually supply, taking into account, in particular, the temperature of each electric motor 15, 17 and the quantity of electrical energy available in the electrical energy source 19.

Finally, the method includes a step 150 of controlling the at least one heat engine 11, 12 and the at least one electric motor 15, 17 carried out by means of each control unit 13, 14 and each control device 16, 18, respectively, according to a distributed operating mode 160, the distributed operating mode 160 applying the first power distribution.

Next, the step 150 of controlling the two heat engines 11, 12 and the two electric motors 15, 17 is carried out by means of the two control units 13, 14 and the two control devices 16, 18, respectively, according to a distributed operating mode in order to propel the rotorcraft 1, optimizing the use of the energy available in the rotorcraft 1. The distributed operating mode applies the previously-determined first power distribution.

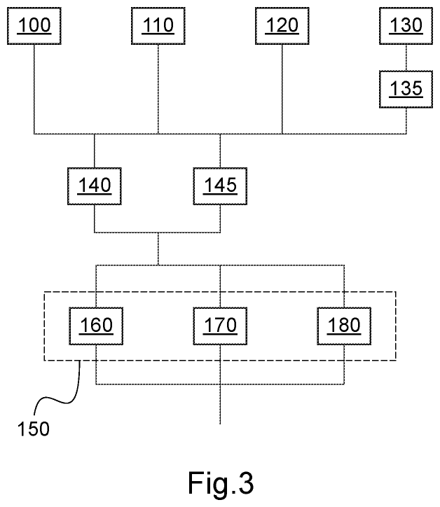

The method for managing the energy supplied by a hybrid power plant 10 for propelling a rotorcraft 1 according to the disclosure may comprise steps in addition to the four main steps described in FIG. 2. FIG. 3 shows an overview diagram of such an energy management method.

For example, the method according to the disclosure may include a step 130 of acquiring at least one second characteristic of the rotorcraft 1 and/or of the hybrid power plant 10. This step 130 of acquiring at least one second characteristic is, for example, carried out by means of the sensor 23 measuring the speed of rotation of the main rotor 2 and/or the sensors 24, 25 measuring the travels of the control stick 31 and of the control lever 32 respectively. Other sensors present in the rotorcraft 1 may also be used.

A second characteristic of the hybrid power plant 10 may be the speed of rotation of a heat engine 11, 12, its temperature or its state of health. A second characteristic of the rotorcraft 1 may be the speed of rotation of the main rotor 2, the altitude of the rotorcraft 1, its forward speed and its vertical speed, or else the value of a collective pitch and/or cyclic pitch control of the blades of the main rotor 2.

One or more second characteristics may be used both during the step 140 of determining a first power distribution and during the step 120 of determining a mechanical power requirement of the rotorcraft 1.

The method according to the disclosure may also comprise a step 135 of determining a flight phase of the rotorcraft 1. The flight phase may be determined conventionally based on the flight conditions of the rotorcraft 1. This step 135 of determining a flight phase of the rotorcraft 1 may in particular be carried out using the second characteristics of the rotorcraft 1 and by means of the calculator 9. A flight phase is, for example, a take-off phase, a landing phase, a hovering flight phase, a level flight phase, a change of altitude phase and/or a maneuvering phase.

The first power distribution may thus be determined as a function of one or more second characteristics and/or the current flight phase of the rotorcraft 1. In this way, the first power distribution can be determined by taking into account the operating conditions of the rotorcraft 1 and the hybrid power plant 10. The first power distribution can thus help optimize the operation of each heat engine 11, 12 depending on these conditions, the electric motors 15, 17 then supplying the additional mechanical power necessary for the flight of the rotorcraft 1.

In this way, the first power distribution can be used to optimize the overall fuel consumption of each heat engine 11, 12 and/or to limit their ageing.

The first power distribution may also be predetermined, as long as the operating conditions of the heat engines 11, 12 and the electric motors 15, 17, as well as the source 19, permit. For example, the mechanical power requirement of the rotorcraft 1 is distributed according to a predetermined percentage between the heat engines 11, 12 and the electric motors 15, 17, as long as this predetermined percentage does not endanger the operation of the heat engines 11, 12 and of the electric motors 15, 17 and as long as the ability of the source 19 allows it. When this predetermined percentage can no longer be complied with, the calculator 9 modifies the first power distribution as a function of one or more first characteristics and the mechanical power requirement and also, possibly, as a function of one or more second characteristics.

For example, according to the predetermined percentage, the mechanical power requirement of the rotorcraft 1 is distributed so that the heat engines 11, 12 provide 80% of this mechanical power requirement and the electric motors 15, 17 provide 20% of this mechanical power requirement. Naturally, other percentages may be used for this power distribution.

In addition, the step 140 of determining a first power distribution may take into account the preservation of a backup electrical energy reserve for the electrical energy source 19. Thus, not all the electrical energy contained in the source 19 is taken into account when determining the first power distribution. Part of this electrical energy is preserved to be used in the event of failure of a heat engine 11, 12 such that the electric motor 15, 17 at least partially compensates for this failure.

The step 140 of determining a first power distribution may also take into account the flight plan of the rotorcraft 1 so that the total quantity of energy contained in the electrical energy source 19 is consumed on this flight plan and the source no longer contains electrical energy at the end of the flight. In particular, the backup reserve may then be used during the landing phase carried out at the end of the flight plan.

Furthermore, the method according to the disclosure may include different operating modes of the hybrid power plant 10 using the heat engines 11, 12 and the electric motors 15, 17 differently, the required operating mode being selected beforehand by a pilot of the rotorcraft, for example.

To this end, the method may comprise the following steps:

selecting 100 an operating mode to select an operating mode of the hybrid power plant 10 by means of a selection device 35; and

controlling 150 the two heat engines 11, 12 and the two electric motors 15, 17 by means of the two control units 13, 14 and the two control devices 16, 18 respectively, according to the operating mode selected from among the following operating modes according to the selection 100:
the distributed operating mode 160 applying said first power distribution;
a total operating mode 170 during which the power supplied by the hybrid power plant 10 is increased, each heat engine 11,12 supplying the maximum available power and each electric motor 15,17 supplying the maximum available power irrespective of the mechanical power requirement of the rotorcraft 1 and within the limits of the capability of the rotorcraft 1; and
a “low-emission” operating mode 180 applying a second power distribution between the two heat engines 11, 12 and the two electric motors 15, 17, the second power distribution limiting polluting emissions from the hybrid power plant 10 for the environment outside the rotorcraft 1.

The selection device 35 may be a manual selector with several positions, such as a rotary knob provided with several positions, or else may be a screen and a touch panel, for example.

The total operating mode makes it possible to provide the maximum available power, for example in order to allow the rotorcraft 1 to take off with a large payload, perform a demanding maneuver, transport a heavy payload, increase the maximum flight altitude, etc.

The “low-emission” operating mode 180 allows a second power distribution in order to limit pollution in the environment outside the rotorcraft 1, which pollution may be noise pollution or else result from the exhaust gases from the heat engines 11, 12. This second power distribution may be predetermined. For example, the two electric motors 15, 17 provide the maximum possible power and energy depending on the quantity of electrical energy available in the source 19 and the two heat engines provide additional power depending on the mechanical power requirement of the rotorcraft. This “low-emission” operating mode 180 is limited in time by the quantity of electrical energy available in the source 19.

The second power distribution may also be calculated in real time by the calculator 9 as a function of one or more first characteristics, the power requirement and, possibly, one or more second characteristics. The second power distribution also takes account of the state of the electrical energy source 19, each electric motor 15, 17 and each heat engine 11, 12, and even the flight conditions of the rotorcraft 1.

In this case, the method according to the disclosure may comprise a step 145 of determining this second power distribution between each heat engine 11, 12 and each electric motor 15, 17 as a function of at least one first characteristic and of the mechanical power requirement of the rotorcraft 1, and possibly of at least one second characteristic.

Furthermore, the total operating mode 170 and/or the “low-emission” operating mode 180 may take into account the preservation of a backup electrical energy reserve for the electrical energy source 19.

Finally, irrespective of the selected operating mode, the first power distribution or the second power distribution may be determined so that at least one electric motor 15, 17 operates in an electrical energy generator mode in order to make it possible to recharge at least one electrical energy source 19 when possible, depending on the power requirement of the rotorcraft 1.

The charging power of the energy source 19 may also be determined as a function of the time required for a complete recharge, subject to its energy absorption capacity, depending, for example, on the temperature of the energy source 19, this temperature possibly increasing during charging.

Naturally, the present disclosure is subject to numerous variations as regards its implementation. Although several embodiments are described above, it should readily be understood that it is not conceivable to identify exhaustively all the possible embodiments.

For example, an example of a rotorcraft having a main lift rotor and an auxiliary rotor has been described. However, the disclosure can be applied to other types of rotorcraft, comprising, for example, a main lift rotor and one or more forward propellers. The disclosure can also be applied to a multirotor rotorcraft comprising several main rotors to ensure the lift, propulsion and maneuverability of the rotorcraft.

It is naturally possible to replace any of the means described with equivalent means without going beyond the ambit of the present disclosure.

What is claimed is:

1. A method for managing the energy supplied by a hybrid power plant for propelling a rotorcraft, the rotorcraft including:
a hybrid power plant provided with at least one heat engine, at least one electric motor, a main gearbox, at least one electrical energy source, one control unit for each heat engine, one control device for each electric motor and at least one sensor for monitoring the electrical energy source(s) or the electric motor(s);
at least one main rotor rotated by the hybrid power plant; and
at least one calculator;
the method comprising the following steps:
acquiring at least one first characteristic of the electrical energy source(s) and/or the electric motor(s) by means of at least one sensor;
determining a mechanical power requirement of the rotorcraft;
determining a first power distribution between the heat engine(s) and the electric motor(s) as a function of the first characteristic(s) and the mechanical power requirement of the rotorcraft; and
controlling the heat engine(s) and the electric motor(s) via the control unit(s) and the control device(s), respectively, according to a distributed operating mode, the distributed operating mode applying the first power distribution,
wherein the method includes a step of determining a flight phase of the rotorcraft, the flight phase being taken into account during the step of determining the first power distribution.

2. The method according to claim 1
wherein the method comprises a step of acquiring at least one second characteristic of the rotorcraft and/or of the hybrid power plant, the second characteristic(s) being used during the step of determining a first power distribution.

3. The method according to claim 1
wherein the method includes a step of acquiring at least one second characteristic of the rotorcraft and/or of the hybrid power plant, the second characteristic(s) being used during the step of determining a mechanical power requirement of the rotorcraft.

4. The method according to claim 2
wherein the second characteristic(s) of the rotorcraft and/or the hybrid power plant is/are chosen from the following list:
speed of rotation of a heat engine;
temperature of a heat engine;
state of health of a heat engine;
speed of rotation of the main rotor;
altitude of the rotorcraft;
forward speed of the rotorcraft;
vertical speed of the rotorcraft;
value of a collective pitch control of the blades of the main rotor; and
value of a cyclic pitch control of the blades of the main rotor.

5. The method according to claim 1
wherein the flight phase is chosen from a list comprising a take-off phase, a landing phase, a hovering flight phase, a level flight phase, a change of altitude phase and a maneuvering phase.

6. The method according to claim 1
wherein the step of determining a first power distribution takes into account the preservation of a backup electrical energy reserve for at least one electrical energy source.

7. The method according to claim 1
wherein the step of determining a first power distribution takes into account a flight plan of the rotorcraft such that the electrical energy source(s) no longer contain(s) any electrical energy at the end of the flight.

8. The method according to claim 1
wherein the first characteristic(s) of the electrical energy source(s) and/or the electric motor(s) is/are chosen from the following list:
a state of charge of the electrical energy source(s);
a depth of discharge of the electrical energy source(s);
a temperature of the electrical energy source(s);
a state of health of the electrical energy source(s); and
a temperature of the electric motor(s).

9. The method according to claim 1
wherein the first power distribution is determined so that the electric motor(s) operate(s) in an electrical energy generator mode so as to recharge at least one electrical energy source.

10. The method according to claim 1
wherein the method comprises the following steps:
selecting an operating mode to select an operating mode of the hybrid power plant by means of a selection device; and
controlling the heat engine(s) and the electric motor(s) via the control unit(s) and the control device(s), respectively, according to the operating mode selected from among the following operating modes depending on the selection:
the distributed operating mode;
a total operating mode during which the power supplied by the hybrid power plant is increased, the heat engine(s) supplying the maximum available power and energy and the electric motor(s) supplying the maximum available power irrespective of the mechanical power requirement of the rotorcraft; and
a “low-emission” operating mode applying a second power distribution between the heat engine(s) and the electric motor(s), the second power distribution limiting polluting emissions from the hybrid power plant for the environment outside the rotorcraft.

11. The method according to claim 9
wherein the total operating mode and/or the “low-emission” operating mode take(s) into account the preservation of a backup electrical energy reserve for at least one electrical energy source in the “low-emission” operating mode.

12. The method according to claim 9
wherein, according to the second power distribution, the electric motor(s) supplie(s) the maximum available energy and the heat engine(s) supplie(s) additional power depending on the mechanical power requirement of the rotorcraft.

13. The method according to claim 10
wherein the method includes a step of determining a second power distribution between the heat engine(s) and the electric motor(s) as a function of the first characteristic(s) and the mechanical power requirement of the rotorcraft.

14. The method according to claim 12
wherein the step of determining a second power distribution takes into account at least one second characteristic of the rotorcraft and/or the hybrid power plant and/or a flight phase of the rotorcraft such that the electrical energy source(s) no longer contain(s) any electrical energy at the end of the flight.

15. A hybrid power plant intended for a rotorcraft,
the hybrid power plant including at least one heat engine, at least one electric motor, a main gearbox, at least one electrical energy source, one control unit for each heat engine, one control device for each electric motor and at least one sensor for monitoring the electrical energy source(s) or the electric motor(s),
wherein the hybrid power plant comprises a calculator configured to implement the method according to claim 1.

16. A rotorcraft comprising the hybrid power plant and at least one main rotor rotated by the hybrid power plant and
wherein the hybrid power plant is according to claim 14.
